(19) United States
(12) Patent Application Publication
(10) Pub. No.: US 2016/0065983 A1
(43) Pub. Date: Mar. 3, 2016

(54) METHOD AND APPARATUS FOR ENCODING MULTI LAYER VIDEO AND METHOD AND APPARATUS FOR DECODING MULTILAYER VIDEO

(71) Applicant: SAMSUNG ELECTRONICS CO., LTD., Gyeonggi-do (KR)

(72) Inventors: Byeong-doo CHOI, Suwon-si (KR); Min-woo PARK, Hwaseong-si (KR); Ho-cheon WEY, Seongnam-si (KR); Jae-won YOON, Seoul (KR); Jin-young LEE, Hwaseong-si (KR); Yong-jin CHO, Seoul (KR)

(73) Assignee: SAMSUNG ELECTRONICS CO., LTD., Suwon-si (KR)

(21) Appl. No.: 14/782,418

(22) PCT Filed: Apr. 7, 2014
(86) PCT No.: PCT/KR2014/002999

§ 371 Date: Oct. 5, 2015

Related U.S. Application Data
(60) Provisional application No. 61/808,827, filed on Apr. 5, 2013.

(51) Int. Cl. H04N 19/50; H04N 19/44; H04N 19/172; H04N 19/187; H04N 19/30

(52) U.S. Cl. CPC H04N 19/50; H04N 19/187; H04N 19/30; H04N 19/172; H04N 19/44

(57) ABSTRACT

A method of prediction decoding a multilayer video is provided. The method includes for each layer of a multilayer video, obtaining information indicating whether a layer included in the multilayer video is used as a reference layer of a current layer; and obtaining an inter layer reference picture set (RPS) of the current layer in which each reference layer is aligned according to a difference value in a layer index value between the current layer and a layer used as the reference layer of the current layer based on the obtained information.

### RELATED APPLICATIONS

This is a national stage application of PCT/KR2014/002999 filed on Apr. 7, 2014 which claims the benefit of U.S. Provisional Application 61/808,827 filed on Apr. 5, 2013, in the United States Patent and Trademark Office, the disclosures of which are hereby incorporated herein in their entirety by reference.

### BACKGROUND

1. Field

Apparatuses and method consistent with exemplary embodiments relate to encoding and decoding of multilayer video, and more particularly to, obtaining a reference image set during a process of decoding multilayer video.

2. Related Art

Generally, video data is encoded according to a designated data compression standard, e.g., a moving picture expert group (MPEG) compression standard, and is stored in a data storage medium or is transmitted via a communication channel in the form of bit streams.

Scalable video encoding (SVC) is a video compression method for suitably adjusting a data amount for transmission in various types of communication networks and terminals. Further, multi-view encoding (MVC) is used for compressing multi-view video, such as 3D pictures.

In SVC and MVC, video is encoded according to a limited encoding method based on macro blocks of designated sizes.

### SUMMARY

One or more exemplary embodiments provide a method of obtaining an inter layer reference picture set (RPS) used to decode layers included in a multilayer video.

One or more exemplary embodiments may also provide a method of obtaining reference layer information of each layer of a multilayer so as to efficiently encode a multilayer video.

According to an aspect of an exemplary embodiment, there is provided a method of prediction decoding a multilayer video, the method including obtaining information indicating whether each layer included in a multilayer video is used as a reference layer of a current layer, for each layer; and obtaining an inter layer reference picture set (RPS) of the current layer in which each reference layer is aligned according to a difference value in a layer index value between the current layer and a layer used as the reference layer of the current layer based on the obtained information.

The obtaining of the information indicating whether each layer included in the multilayer video is used as the reference layer of the current layer, for each layer, may include: sequentially obtaining information indicating whether each layer that belongs to a subordinate layer of the current layer is the reference layer of the current layer in a descending order based on the layer index value of the current layer, wherein the inter layer RPS includes at least one reference layer aligned in an order in which the information is obtained.

The method may further include: realigning at least one reference layer included in the inter layer RPS according to scalability dimension information of the current layer.

The method may further include: obtaining an index value according to the scalability dimension information with respect to each layer, wherein the realigning of the at least one reference layer includes: realigning the at least one reference layer included in the inter layer RPS according to a difference in the index value of the scalability dimension information between the current layer and the at least one reference layer.

The method may further include: obtaining a reference picture list with respect to the current layer according to an order of reference layers included in the inter layer RPS; and prediction decoding the current layer according to the reference picture list.

According to an aspect of an exemplary embodiment, there is provided an apparatus for decoding a multilayer video, the apparatus including a parser for obtaining information indicating whether each layer included in a multilayer video is used as a reference layer of a current layer, for each layer, and obtaining an inter layer RPS of the current layer in which each reference layer is aligned according to a difference value in a layer index value between the current layer and a layer used as the reference layer of the current layer based on the obtained information; and a video decoder for prediction decoding a picture of the current layer.

According to an aspect of an exemplary embodiment, there is provided a method of prediction encoding a multilayer video, the method including: determining information indicating whether each layer included in a multilayer video is used as a reference layer of a current layer, for each layer; and obtaining an inter layer RPS of the current layer in which each reference layer is aligned according to a difference value in a layer index value between the current layer and a layer used as the reference layer of the current layer based on the determined information.

According to an aspect of an exemplary embodiment, there is provided an apparatus for encoding a multilayer video, the apparatus including: a video encoder for performing intra prediction, inter prediction, and inter layer prediction on pictures included in a multilayer video and determining information indicating whether each layer included in the multilayer is video used as a reference layer of a current layer, for each layer; and an RPS information generator for generating an inter layer RPS of the current layer in which each reference layer is aligned according to a difference value in a layer index value between the current layer and a layer used as the reference layer of the current layer based on the determined information.

According to an aspect of an exemplary embodiment, there is provided a computer readable recording medium having recorded thereon a program for executing the inter prediction method.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a block diagram of a video encoding apparatus according to an exemplary embodiment;

FIG. 2 is a block diagram of a video decoding apparatus according to an exemplary embodiment;

FIG. 3 is a diagram for describing a concept of coding units according to an exemplary embodiment;

FIG. 4 is a block diagram of an image encoder based on coding units, according to an exemplary embodiment;

FIG. 5 is a block diagram of an image decoder based on coding units, according to an exemplary embodiment;

FIG. 6 is a diagram illustrating deeper coding units according to depths, and partitions, according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths, according to an exemplary embodiment;

FIGS. 10 through 12 are diagrams for describing a relationship between coding units, prediction units, and frequency transform units, according to an exemplary embodiment;

FIG. 13 is a diagram for describing a relationship between a coding unit, a prediction unit, and a transform unit, according to encoding mode information of Table 1;

FIG. 14 is a block diagram of a multi-layer video encoding apparatus according to an exemplary embodiment;

FIG. 15 is a flowchart showing a method of encoding multi-layer video, according to an exemplary embodiment;

FIG. 16 is a diagram illustrating an example of inter-layer estimation structures according to an exemplary embodiment;

FIG. 17 is a block diagram of a multi-layer video decoding apparatus according to an exemplary embodiment;

FIG. 18 is a flowchart of a method of prediction decoding a multilayer video by obtaining an inter layer reference picture set (RPS) according to an exemplary embodiment;

FIG. 19 is a flowchart of a method of obtaining an inter layer RPS of a current layer according to an exemplary embodiment;

FIG. 20 is a flowchart of a method of obtaining an inter layer RPS based on scalability dimension information according to an exemplary embodiment;

FIG. 21 is a diagram of an example of a method of obtaining an inter layer RPS according to an exemplary embodiment;

FIG. 22 illustrates a code of an example of obtaining an inter layer RPS according to an exemplary embodiment;

FIG. 23 illustrates a code of an example of obtaining an inter layer RPS based on scalability dimension information according to an exemplary embodiment; and

FIG. 24 illustrates a syntax of an example of obtaining scalability dimension information according to an exemplary embodiment.

### DETAILED DESCRIPTION OF EXEMPLARY EMBODIMENTS

Hereinafter, the exemplary embodiments will be described in detail with reference to the attached drawings. However, in the description and the drawings, detailed descriptions about related functions or configurations that may obscure the description of the exemplary embodiments are omitted. Like reference numerals in the drawings denote like elements.

The terms and words which are used in the present specification and the appended claims may be construed to fit to the technological concept and scope. It should be understood, however, that the exemplary embodiments are not limited to the particular forms disclosed herein, and may cover all modifications, equivalents, and alternatives falling within the spirit and scope of the inventive concept.

In the present specification, it should be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. The terms, such as ‘unit’ or ‘module’, etc., should be understood as a unit that processes at least one function or operation and that may be embodied in a hardware manner, a software manner, or a combination of the hardware manner and the software manner.

Throughout the specification, the term “image” means a “frame”, a “field”, and a “slice” as well as the term “image” as well and may be used as a comprehensive term for explaining various types of video image information that may be known to a related field.

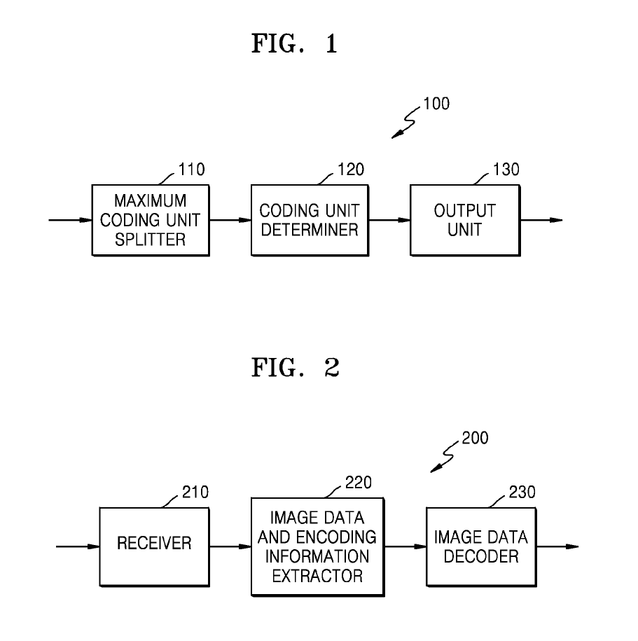

FIG. 1 is a block diagram of a video encoding apparatus 100 according to an exemplary embodiment.

The video encoding apparatus 100 according to an exemplary embodiment includes a maximum coding unit splitter 110, a coding unit determiner 120, and an output unit 130 (e.g., an output, etc.).

The maximum coding unit splitter 110 may split a current picture based on a maximum coding unit that is a coding unit having a maximum size for a current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2 or 2ⁿ. Each of the width and length are larger than 8. The image data may be output to the coding unit determiner 120 according to the at least one maximum coding unit.

A coding unit according to an exemplary embodiment may be characterized by a maximum size and a depth. The depth denotes the number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Even if coding units correspond to the same depth in one maximum coding unit, it is determined whether to split each of the coding units corresponding to the same depth to a lower depth by measuring an encoding error of the image data of the each coding unit, separately. Accordingly, even when image data is included in one maximum coding unit, the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 according to an exemplary embodiment may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3, and 4 exist, and thus the first maximum depth may be set to 4, and the second maximum depth may be set to 5.

Prediction encoding and frequency transformation may be performed according to the maximum coding unit. The prediction encoding and the frequency transformation are also performed based on the deeper coding units according to a depth equal to or depths less than the maximum depth, according to the maximum coding unit.

Since the number of deeper coding units increases whenever the maximum coding unit is split according to depths, encoding, including the prediction encoding and the transformation, is performed on all of the deeper coding units generated as the depth increases. For convenience of description, the prediction encoding and the transformation will now be described based on a coding unit of a current depth, in a maximum coding unit.

The video encoding apparatus 100 according to an exemplary embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one selected from a height and a width of the prediction unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one selected from an intra mode, a inter mode, and a skip mode. For example, the intra mode or the inter mode may be performed on the partition of 2N×2N, 2N×N, N×2N, or N×N. The skip mode may be performed only on the partition of 2N×2N. The encoding is independently performed on one prediction unit in a coding unit, thereby selecting a prediction mode having a least encoding error.

The video encoding apparatus 100 according to an exemplary embodiment may also perform the frequency transformation on the image data in a coding unit based not only on the coding unit for encoding the image data, but also based on a data unit that is different from the coding unit.

In order to perform the frequency transformation in the coding unit, the frequency transformation may be performed based on a data unit having a size smaller than or equal to the coding unit. For example, the data unit for the frequency transformation may include a data unit for an intra mode and a data unit for an inter mode.

Hereinafter, the data unit that is a basis of the frequency transformation may be referred to as a “transform unit”. The transform unit in the coding unit may be recursively split into smaller sized regions in a manner similar to that in which the coding unit is split according to the tree structure according to an exemplary embodiment. Thus, residual data in the coding unit may be divided according to the transform unit having the tree structure according to transformation depths.

A transformation depth indicating the number of splitting times to reach the transform unit by splitting the height and width of the coding unit may also be set in the transform unit according to an exemplary embodiment. For example, in a current coding unit of 2N×2N, a transformation depth may be 0 when the size of a transform unit is 2N×2N, may be 1 when the size of the transform unit is N×N, and may be 2 when the size of the transform unit is N/2×N/2. In other words, the transform unit having the tree structure may be set according to the transformation depths.

Encoding information according to coding units corresponding to a coded depth requires not only information about the coded depth, but also about information related to prediction encoding and frequency transformation. Accordingly, the coding unit determiner 120 not only determines a coded depth having a least encoding error, but also determines a partition type in a prediction unit, a prediction mode according to prediction units, and a size of a transform unit for frequency transformation.

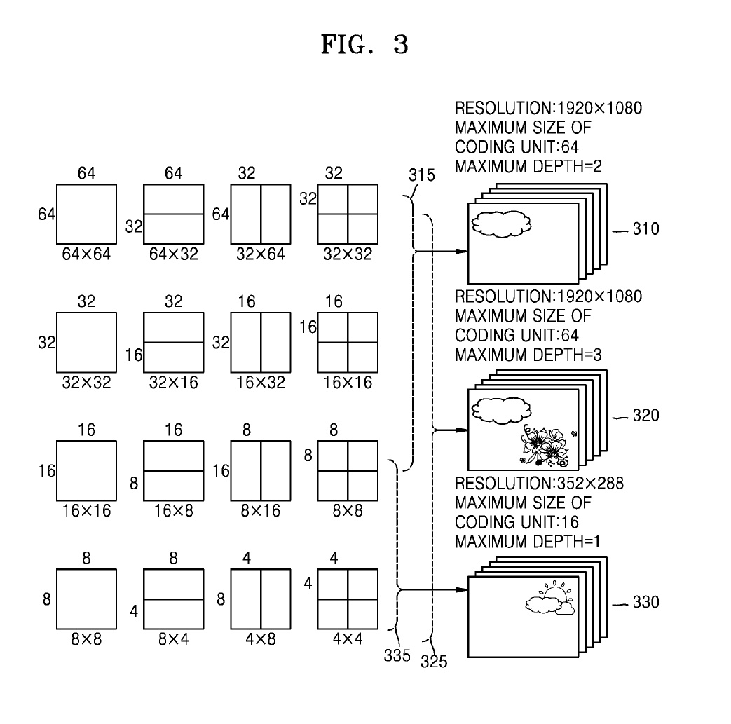

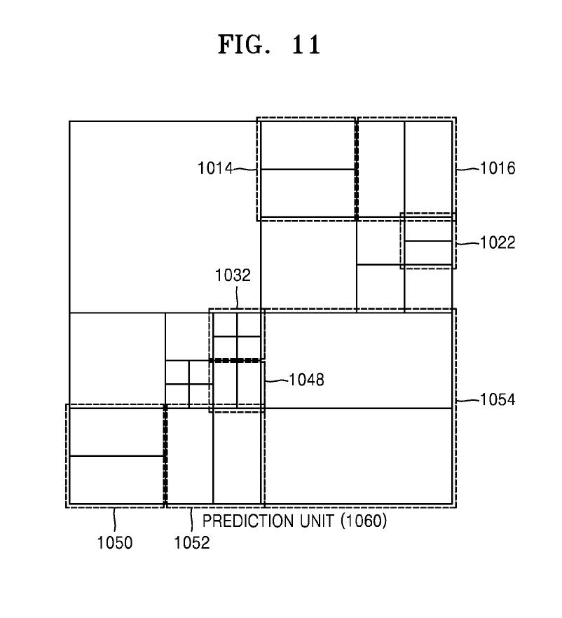

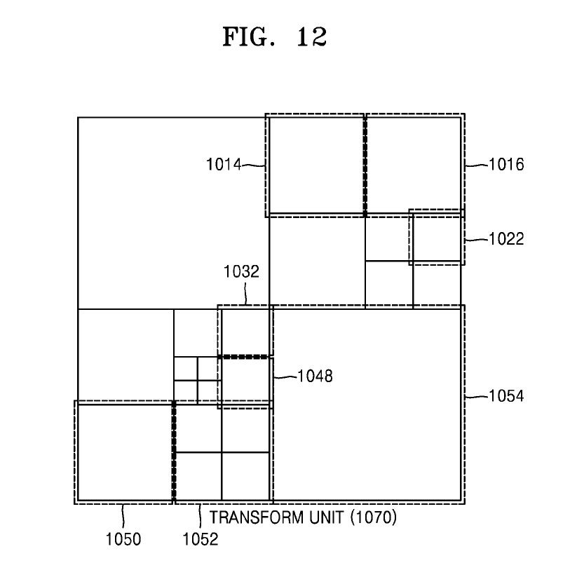

Coding units according to a tree structure in a maximum coding unit and a method of determining a partition according to exemplary embodiments will be described in detail later with reference to FIGS. 3 through 12.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transform unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. A coded depth of the image data of the maximum coding unit may be different according to locations since the image data is hierarchically split according to depths, and thus information about the coded depth and the encoding mode may be set for the image data.

Accordingly, the output unit 130 according to an exemplary embodiment may assign encoding information about a corresponding coded depth and an encoding mode to at least one selected from the coding unit, the prediction unit, and a minimum unit included in the maximum coding unit.

The minimum unit according to an exemplary embodiment is a square data unit obtained by splitting the minimum coding unit constituting the lowermost depth by 4. Alternatively, the minimum unit according to an exemplary embodiment may be a maximum square data unit that may be included in all of the coding units, prediction units, partition units, and transform units included in the maximum coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Information about a maximum size of the coding unit defined according to pictures, slices, or GOPs, and information about a maximum depth may be inserted into a header of a bitstream.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. The coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Since encoding may be performed on each maximum coding unit by using any one of various prediction modes and frequency transformations, an optimum encoding mode may be determined considering characteristics of the coding unit of various image sizes.

Thus, if an image having a high resolution or a large data amount is encoded in a macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

FIG. 2 is a block diagram of a video decoding apparatus 200 according to an exemplary embodiment.

The video decoding apparatus 200 according to an exemplary embodiment includes a receiver 210, an image data and encoding information extractor 220, and an image data decoder 230. Definitions of various terms, such as a coding unit, a depth, a prediction unit, a transform unit, and information about various encoding modes, for various processing of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

The image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transform unit. Splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode according to an exemplary embodiment may be assigned to a predetermined data unit from among a corresponding coding unit, a prediction unit, and a minimum unit, the image data and encoding information extractor 220 may extract the information about the coded depth and the encoding mode according to the predetermined data units. If information about a coded depth and encoding mode of a corresponding maximum coding unit is recorded according to predetermined data units, the predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transform unit for each coding unit from among the coding units having the tree structure included in each maximum coding unit. A decoding process may include a prediction including intra prediction and motion compensation, and a frequency inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may perform inverse transformation based on transform units for each coding unit based on size information a transform unit of a coding unit according to coding depths, for frequency inverse transformation for each maximum coding unit.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data in the current maximum coding unit by using the information about the partition type of the prediction unit, the prediction mode, and the size of the transform unit for each coding unit corresponding to the coded depth.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

Thus, the video decoding apparatus 200 according to an exemplary embodiment may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

Hereinafter, coding units, a prediction unit, and a transform unit according to a tree structure according to an exemplary embodiment will be described in detail later with reference to FIGS. 3 through 13.

FIG. 3 is a diagram for describing a concept of coding units according to an exemplary embodiment.

A size of a coding unit may be expressed by width x height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are increased to two layers by splitting the maximum coding unit twice. Since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be precisely expressed.

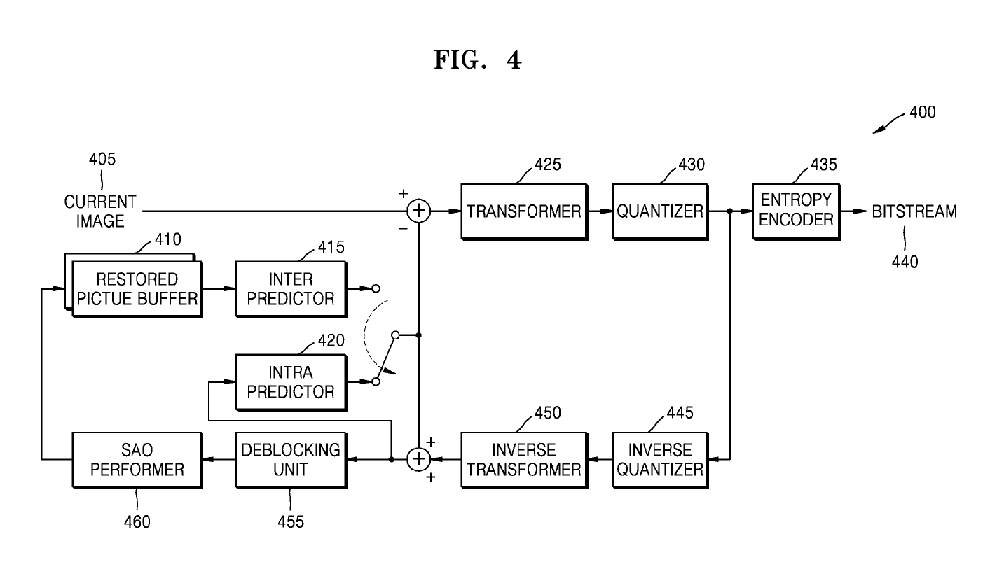

FIG. 4 is a block diagram of an image encoder 400 based on coding units, according to an exemplary embodiment.

The image encoder 400 according to an exemplary embodiment performs operations of the coding unit determiner 120 of the video encoding apparatus 100 to encode image data. In other words, an intra estimator 420 performs, based on an estimation unit, intra estimation on encoding units in an intra mode, from a current picture 405, and an inter estimator 415 performs, based on estimation units, inter estimation on encoding units in an inter mode from the current picture 405 by using the current picture 405 and reference frame obtained from a restored picture buffer 410. The current picture 405 may be divided into maximum encoding units and may be sequentially encoded. In this case, encoding may be performed with respect to encoding units that are to be formed by dividing a maximum encoding unit in a tree structure.

Residue data is generated by subtracting estimation data related to encoding units of the respective modes output by the intra estimator 420 or the inter estimator 415 from data related to encoding units from the current picture 405 that is being encoded, and the residue data is output as a quantized transformation coefficient through a transformer 425 and a quantizer 430. The quantized transformation coefficient is restored as residue data in the spatial domain through an inverse quantizer 445 and an inverse transformer 450. The residue data in the spatial domain is restored as data in the spatial domain related to encoding units of the current picture 405 by being added to the estimation data related to encoding units of the respective modes output by the intra estimator 420 or the inter estimator 415. The restored data in the spatial domain is output as a restored picture after being post-processed through a deblocking unit 455 and a SAO performing unit 460. Restored pictures stored in the restored picture buffer 410 may be used as reference pictures for inter estimating other pictures. The transformation coefficient quantized by the transformer 425 and the quantizer 430 may be output as a bitstream 440 through an entropy encoder 435.

In order to use the image encoder 400 in the video encoding apparatus 100, all elements of the image encoder 400, i.e., the intra estimator 415, the intra estimator 420, the transformer 425, the quantizer 430, the entropy encoder 435, the inverse quantizer 445, the inverse transformer 450, the deblocking unit 455, and the SAO performing unit 460 may perform operations based on each encoding unit from among encoding units having a tree structure of each maximum encoding unit.

Specifically, the intra estimator 420 and the inter estimator 415 determines a partition mode and an estimation mode of each encoding unit from among the encoding units having a tree structure by considering the maximum size and the maximum depth of a current maximum encoding unit, and the transformer 425 determines whether to split the transform unit in each encoding unit based on a quad tree from among the encoding units having a tree structure.

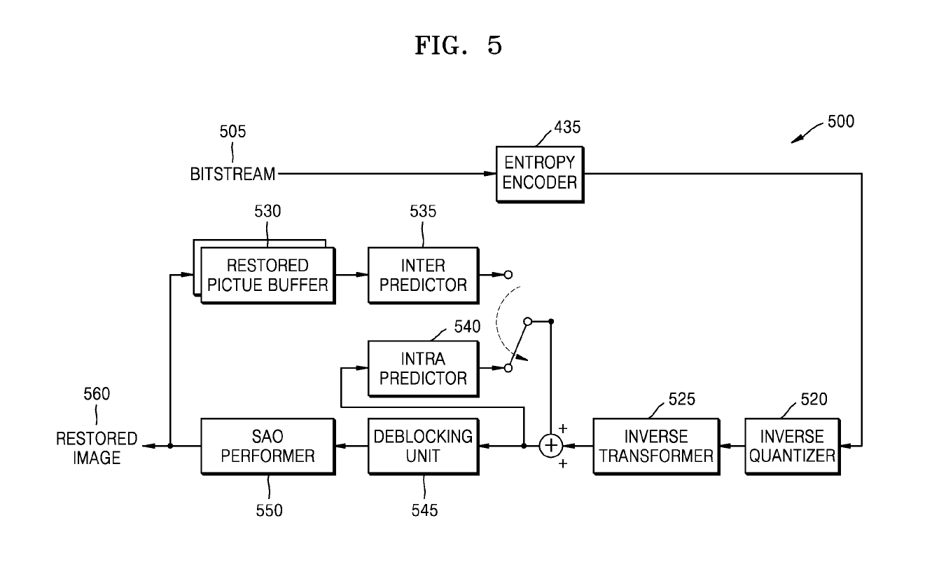

FIG. 5 is a block diagram of an image decoder 500 based on coding units, according to an exemplary embodiment.

An entropy decoder 515 parses encoded image data to be decoded and information about encoding required for decoding from a bitstream 505. The encoded image data is quantized transformation coefficient, where an inverse quantizer 520 and an inverse transformer 525 restore residue data from the quantized transformation coefficient.

An intra estimator 540 performs intra estimation on encoding units in an intra mode. An inter estimator 535 performs inter estimation on encoding units in an inter mode from among the current picture 405 by using the current picture 405 and reference frame obtained from a restored picture buffer 530, based on estimation units

Data in a spatial domain is restored as estimation data related to encoding units of the respective modes output by the intra estimator 540 or the inter estimator 535 is added to residue data, and the restored data in the spatial domain may be output as a restored picture 560 after being post-processed through a deblocking unit 545 and a SAO performing unit 550. Furthermore, restored pictures stored in the restored picture buffer 530 may be output as reference pictures

In order to decode the image data in the image data decoder 230 of the video decoding apparatus 200, the image decoder 500 may perform operations that are performed after operations of the entropy decoder 515 may be performed.

In order for the image decoder 500 to be applied in the video decoding apparatus 200, all elements of the image decoder 500, i.e., the entropy decoder 515, the inverse quantizer 520, the inverse transformer 530, the intra estimator 540, the inter estimator 535, the deblocking unit 545, and the SAO performing unit 550 may perform operations based on encoding units having a tree structure for each maximum encoding unit.

Specifically, the intra estimator 540 and the inter estimator 535 determine a partition mode and an estimation mode for each of the encoding units having a tree structure, and the inverse transformer 525 determines whether to split the transform unit in each encoding unit based on a quad tree from among the encoding units having a tree structure.

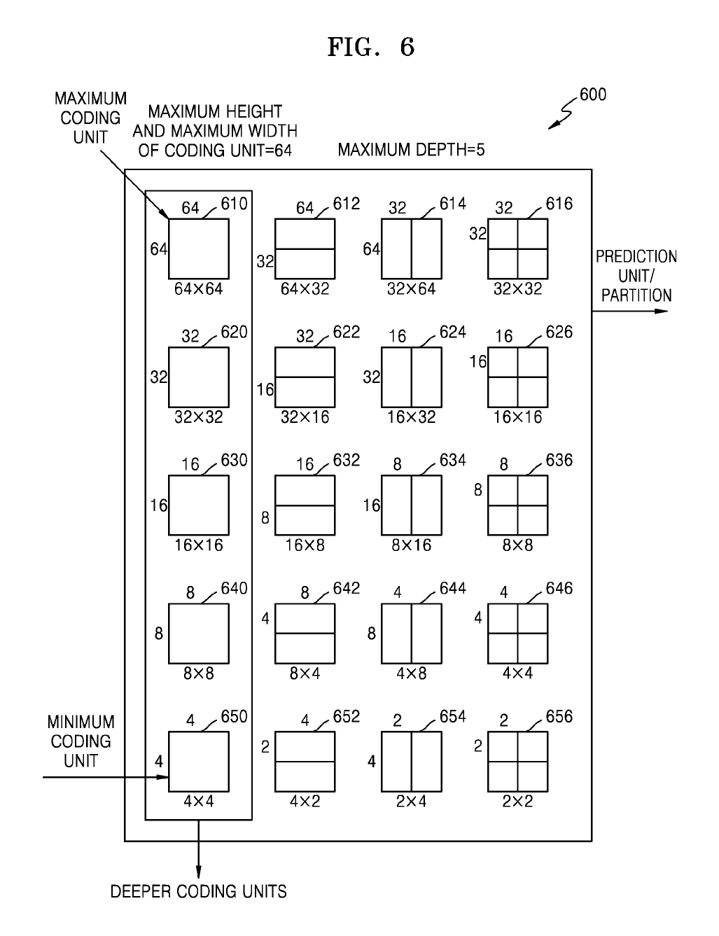

FIG. 6 is a diagram illustrating deeper coding units according to depths, and partitions, according to an exemplary embodiment.

The video encoding apparatus 100 according to an exemplary embodiment and the video decoding apparatus 200 according to an exemplary embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an exemplary embodiment, according to an exemplary embodiment, the maximum height and the maximum width of the coding units are each 64, and the maximum depth is 4. In this case, the maximum depth refers to a total number of times the coding unit is split from the maximum coding unit to the minimum coding unit. Since a depth increases along a vertical axis of the hierarchical structure 600 according to an exemplary embodiment, a height and a width of the deeper coding unit are each split. Moreover, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4. The coding unit 650 having the size of 4×4 and the depth of 4 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

Lastly, the coding unit 650 having the size of 4×4 and the depth of 4 may be the minimum coding unit and a coding unit of a lowest depth, and a corresponding prediction unit may be set as the coding unit 650 having the size of 4×4. According to another exemplary embodiment, the coding unit 650 may be split into partitions included in the coding unit 650, i.e. a partition having a size of 4×4 included in the coding unit 650, partitions 652 having a size of 4×2, partitions 654 having a size of 2×4, and partitions 656 having a size of 2×2.

In order to determine the at least one coded depth of the coding units constituting the maximum coding unit 610, the coding unit determiner 120 of the video encoding apparatus 100 according to an exemplary embodiment performs encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth increases along the vertical axis of the hierarchical structure 600. A depth and a partition having the minimum encoding error in the coding unit 610 may be selected as the coded depth and a partition type of the coding unit 610.

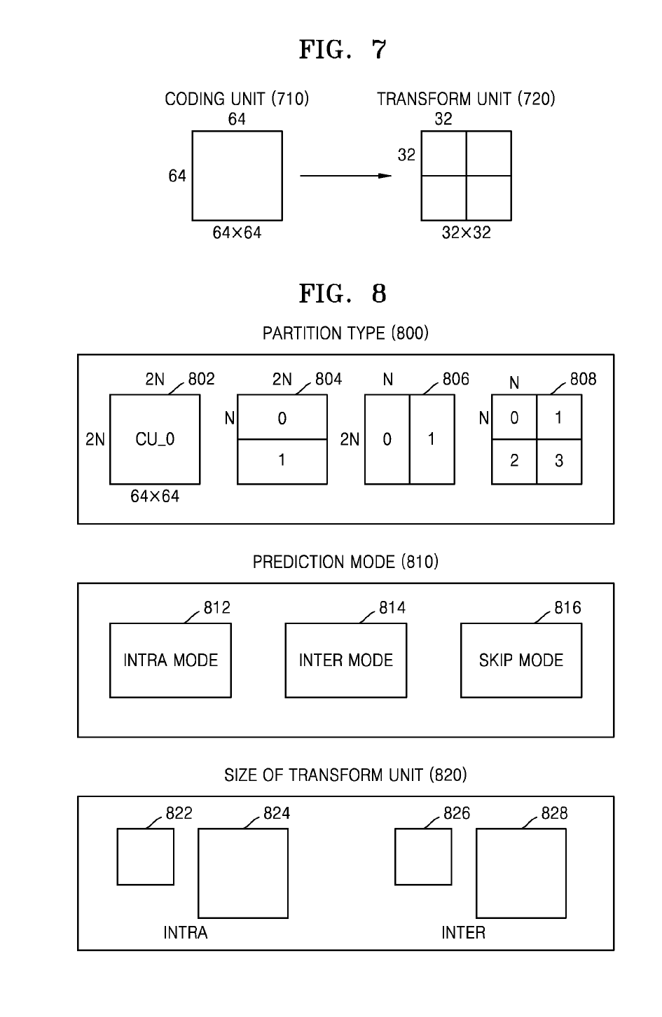

FIG. 7 is a diagram for describing a relationship between a coding unit 710 and transform units 720, according to an exemplary embodiment.

The video encoding apparatus 100 according to an exemplary embodiment or the video decoding apparatus 200 according to an exemplary embodiment encodes or decodes an image according to coding units having sizes smaller than or equal to a maximum coding unit for each maximum coding unit. Sizes of transform units for transformation during encoding may be selected based on data units that are not larger than a corresponding coding unit.

For example, in the video encoding apparatus 100 according to an exemplary embodiment or the video decoding apparatus 200 according to an exemplary embodiment, if a size of the coding unit 710 is 64×64, transformation may be performed by using the transform units 720 having a size of 32×32.

Data of the coding unit 710 having the size of 64×64 may be encoded by performing the transformation on each of the transform units having the size of 32×32, 16×16, 8×8, and 4×4, which are smaller than 64×64, and then a transform unit having the least coding error may be selected.

FIG. 8 is a diagram fro describing encoding information of coding units corresponding to a coded depth, according to an exemplary embodiment.

The output unit 130 of the video encoding apparatus 100 according to an exemplary embodiment may encode and transmit information 800 about a partition type, information 810 about a prediction mode, and information 820 about a size of a transform unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transform unit to be based on when transformation is performed on a current coding unit. For example, the transform unit may be a first intra transform unit 822, a second intra transform unit 824, a first inter transform unit 826, or a second intra transform unit 828.

The image data and encoding information extractor 220 of the video decoding apparatus 200 may extract and use the information 800, 810, and 820 for decoding, according to each deeper coding unit.

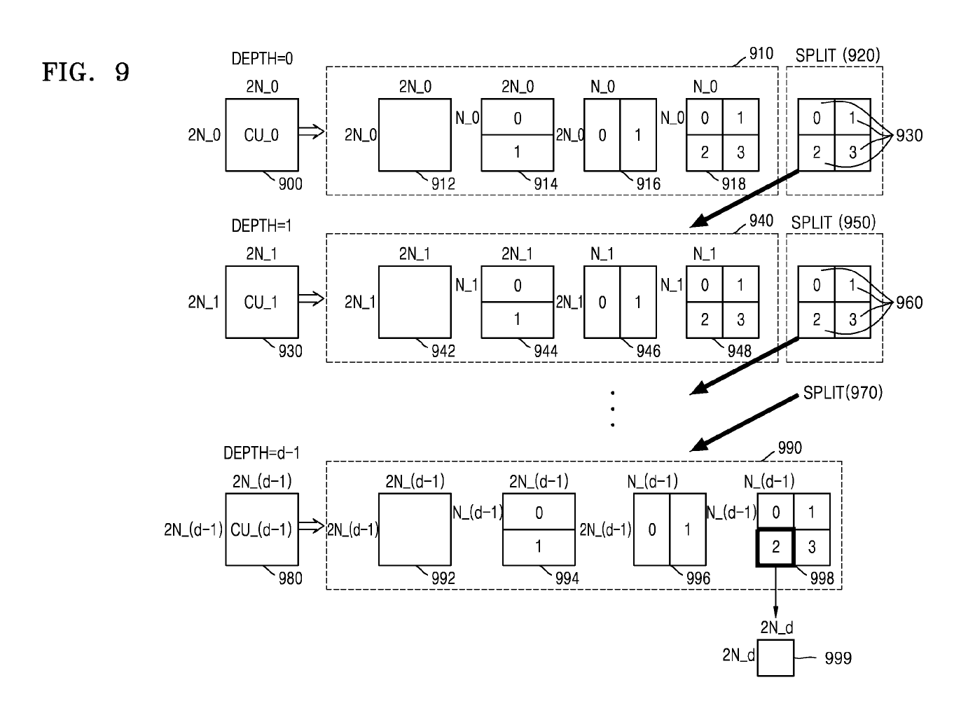

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an exemplary embodiment may be a square data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Since a coding unit is split from a depth of 0 to a coded depth, only split information of the coded depth is set to 0, and split information of depths excluding the coded depth is set to 1.

The image data and encoding information extractor 220 of the video decoding apparatus 200 according to an exemplary embodiment may extract and use the information about the coded depth and the prediction unit of the coding unit 900 to decode the partition 912. The video decoding apparatus 200 according to an exemplary embodiment may determine a depth, in which split information is 0, as a coded depth by using split information according to depths, and use information about an encoding mode of the corresponding depth for decoding.

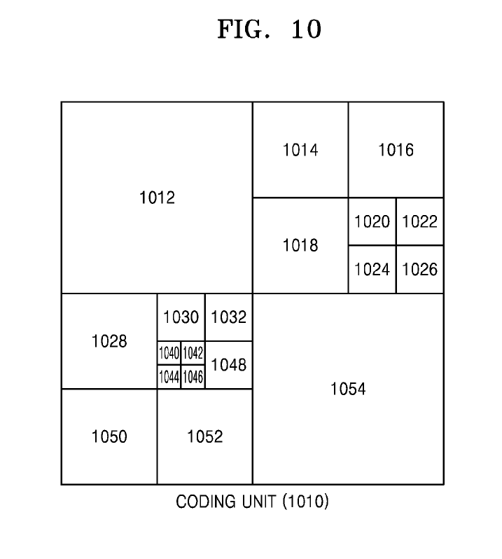

FIGS. 10 through 12 are diagrams for describing a relationship between coding units 1010, prediction units 1060, and transform units 1070, according to an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transform units 1070 are transform units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transform units 1070 in a data unit that is smaller than the coding unit 1052. The coding units 1014, 1016, 1022, 1032, 1048, 1050, and 1052 in the transform units 1070 are different from those in the prediction units 1060 in terms of sizes and shapes. In other words, the video encoding and decoding apparatuses 100 and 200 according to exemplary embodiments may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transform unit. Table 1 shows the encoding information that may be set by the video encoding and decoding apparatuses 100 and 200 according to exemplary embodiments.

TABLE 1

| Split Information 0 | | | | | |
|---|---|---|---|---|---|
| (Encoding on Coding Unit having Size of 2N × 2N | | | | | |
| and Current Depth of d) | | | | | |
| | | | Size of Transform unit | | |
| | | | Split | | |
| | Partition Type | | Information | Split | |
| | Symmetrical | Asymmetrical | 0 of | Information 1 | |
| Prediction | Partition | Partition | Transform | of Transform | Split |
| Mode | Type | Type | unit | unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding |
| (Only | N × N | nR × 2N | | N/2 × N/2 | Units |
| 2N × 2N) | | | | (Asymmetrical | having |
| | | | | Type) | Lower |
| | | | | | Depth of |
| | | | | | d + 1 |

The output unit 130 of the video encoding apparatus 100 according to an exemplary embodiment may output the encoding information about the coding units having a tree structure, and the image data and encoding information extractor 220 of the video decoding apparatus 200 according to an exemplary embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transform unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transform unit may be set to be two types in the intra mode and two types in the inter mode. In other words, if split information of the transform unit is 0, the size of the transform unit may be 2N×2N, which is the size of the current coding unit. If split information of the transform unit is 1, the transform units may be obtained by splitting the current coding unit. If a partition type of the current coding unit having the size of 2N×2N is a symmetrical partition type, a size of a transform unit may be N×N, and if the partition type of the current coding unit is an asymmetrical partition type, the size of the transform unit may be N/2×N/2.

The encoding information about coding units having a tree structure according to an exemplary embodiment may include at least one selected from a coding unit corresponding to a coded depth, a prediction unit, and a minimum unit. The coding unit corresponding to the coded depth may include at least one selected from a prediction unit and a minimum unit containing the same encoding information.

Accordingly, it is determined whether adjacent data units are included in the same coding unit corresponding to the coded depth by comparing encoding information of the adjacent data units. A corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

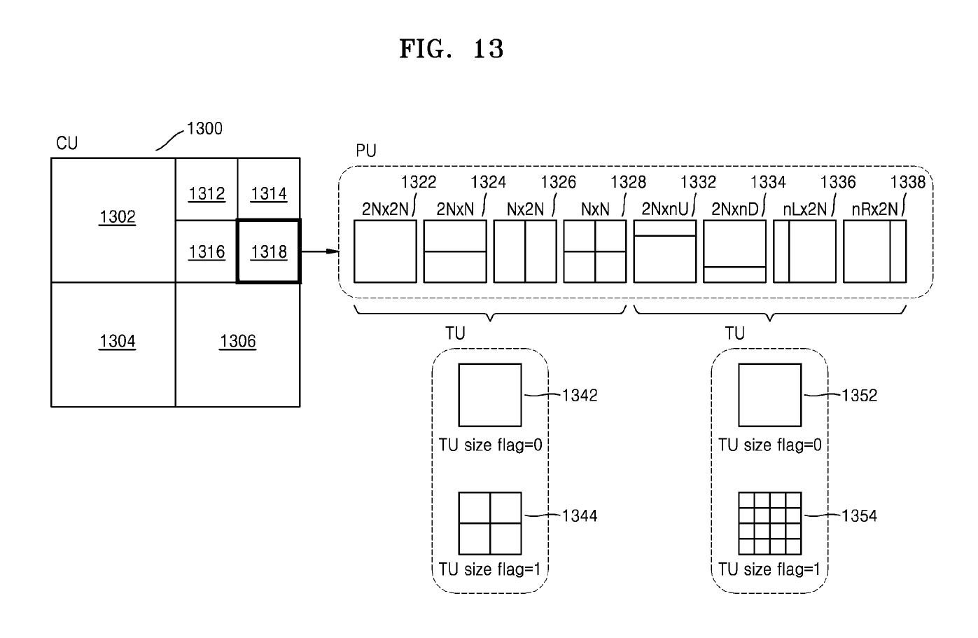

FIG. 13 is a diagram for describing a relationship between a coding unit, a prediction unit, and a transform unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322, 1324, 1326, or 1328, a transform unit 1342 having a size of 2N×2N is set if a TU size flag of a transform unit is 0, and a transform unit 1344 having a size of N×N is set if a TU size flag is 1.

When the partition type is set to be asymmetrical, i.e., the partition type 1332, 1334, 1336, or 1338, a transform unit 1352 having a size of 2N×2N is set if a TU size flag is 0, and a transform unit 1354 having a size of N/2×N/2 is set if a TU size flag is 1.

The maximum coding unit including coding units of the tree structure described with reference to FIGS. 1 through 13 may be named as a coding block tree, a block tree, a root block tree, a coding tree, a coding root or a tree trunk in various ways.

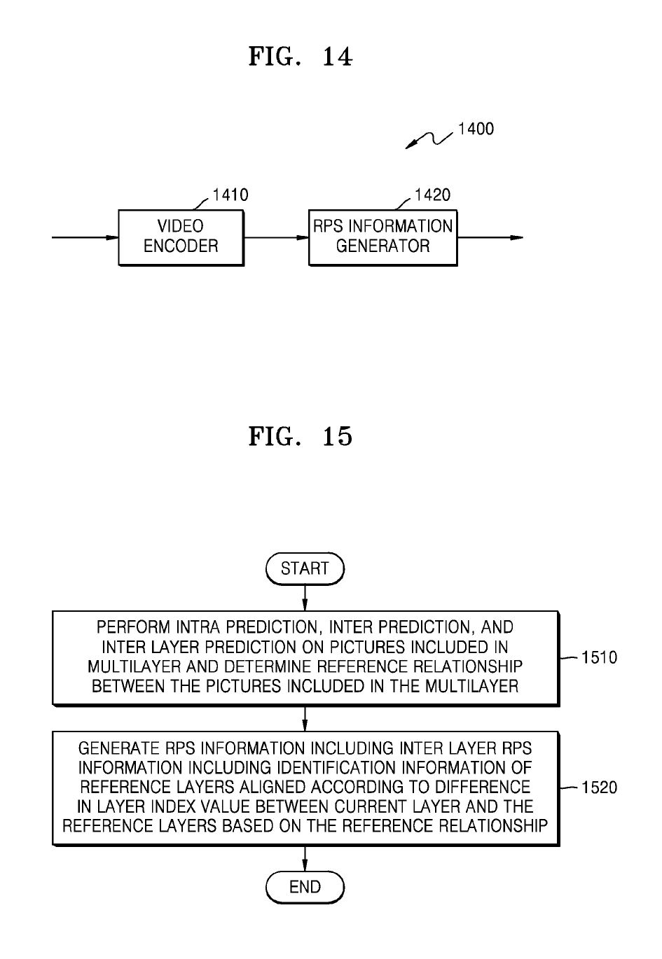

Hereinafter, a method of encoding a multi layer video and a method of decoding a multi layer video are described with reference to FIGS. 14 through 20. Hereinafter, an “image” may refer to a still image or a moving image, that is, a video. An encoding order is an order of processing an image in an encoding side, a decoding order is an order of processing an image in a decoding side, and the encoding order and the decoding order are the same.

FIG. 14 is a block diagram of a multi-layer video encoding apparatus 1400 according to an exemplary embodiment.

Referring to FIG. 14, the multi-layer video encoding apparatus 1400 includes a video encoder 1410 and a reference picture set (RPS) information generator 1420.

The video encoder 1410 receives and encodes multi-layer video. The video encoder 1410 corresponds to a video coding layer which encodes input video.

As described above with reference to FIGS. 1 through 13, the video encoder 1410 according to an exemplary embodiment splits each of pictures included in multi-layer video into maximum encoding units having a maximum size, splits the split maximum encoding units into encoding units, and encodes each of the pictures based on the encoding units. The encoding units have a tree structure formed by hierarchically splitting the maximum encoding unit according to depths.

The video encoder 1410 performs estimations with respect to encoding units by using estimation units and transforms residual data, which include differences between estimated values and original signals, by using transform units.

Multi-layer video may be multi-viewpoint video or scalable video. If multi-layer video is multi-viewpoint video, the video encoder 1410 encodes each of picture sequences of n (n is a natural number) viewpoints as a single layer. If multi-layer video is scalable video, the video encoder 1410 encodes picture sequence of a base layer and respective picture sequences of an enhancement layer.

Multi-layer video includes larger amount of data as compared to single-layer video. Therefore, the video encoder 1410 may perform estimation encoding by using correlations between pictures of the respective layer included in multi-layer video. In other words, the video encoder 1410 may estimation encode a picture of each layer based on a picture of another layer. The estimation based on picture of a current layer and picture of another layer will be referred to as an inter-layer estimation.

For example, the video encoder 1410 may perform inter-view estimation for estimating pictures of additional viewpoints based on pictures of basic viewpoints. Furthermore, the video encoder 1410 may perform inter-view estimation for estimating pictures of other additional viewpoints based on pictures of predetermined additional viewpoints. Through an inter-view estimation, a disparity between a current picture and a reference picture and a residual, which is a difference between the current picture and the reference picture, may be generated. As described above, the inter-layer estimation may be performed based on encoding units having a tree structure, estimation units, or transform units.

The video encoder 1410 may determine reference relationships between pictures included in multi-layers by performing an inter estimation and an intra estimation in pictures of a same layer or performing an inter-layer estimation using a picture of another layer. Furthermore, the video encoder 1410 may perform an encoding by performing an inter estimation, performing an intra estimation, and transforming and quantizing differences between estimated values generated during an inter-layer estimation and original signals. Through such an encoding operation at the VCL, the video encoder 1410 outputs residual information regarding encoding units, estimation mode information, and additional information regarding estimation encoding of the encoding units.

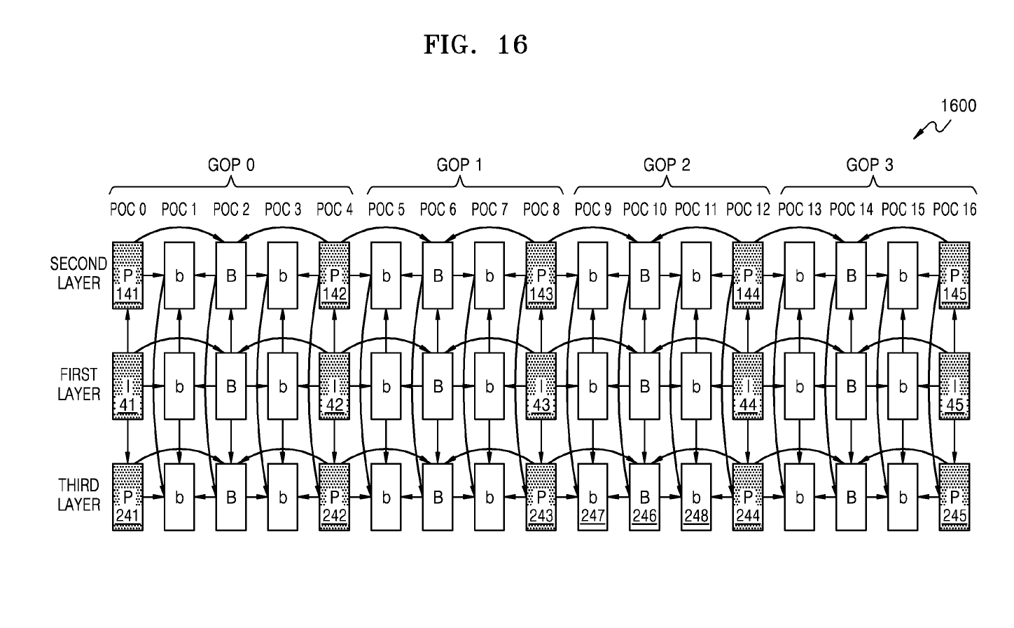

FIG. 16 is a diagram illustrating an example of inter-layer estimation structures according to an exemplary embodiment.

As described above, the multi-layer video encoding apparatus 1400 according to an exemplary embodiment may perform an inter-layer estimation for estimation encoding pictures of each layer based on pictures of another layer. For example, the inter-layer estimation structure 1600 shown in FIG. 16 indicates an estimation structure for estimation-encoding stereoscopic picture sequence including a first layer picture corresponding to the center viewpoint, a second layer picture corresponding to the left viewpoint, and a third layer picture corresponding to the right viewpoint. In FIG. 16, the arrows indicate referring directions of the respective pictures. For example, an I picture 41 of a first layer is used as a reference picture for a P picture 141 of a second layer and a P picture 241 of a third layer. Further, a B picture 246 is used as a reference for b pictures 247 and 248. Furthermore, pictures having a same POC sequence are arranged in the vertical direction. A POC sequence of pictures indicate a sequence of outputting or playing back pictures constituting video data. In the inter-layer estimation structure 1600, ‘POC #’ is indicate a sequence of outputting pictures located in a row. Four successive pictures constitute one group of pictures (GOP) per viewpoint. Each GOP includes pictures between successive key pictures and one key picture. Number and sequence of pictures included in a GOP may vary.

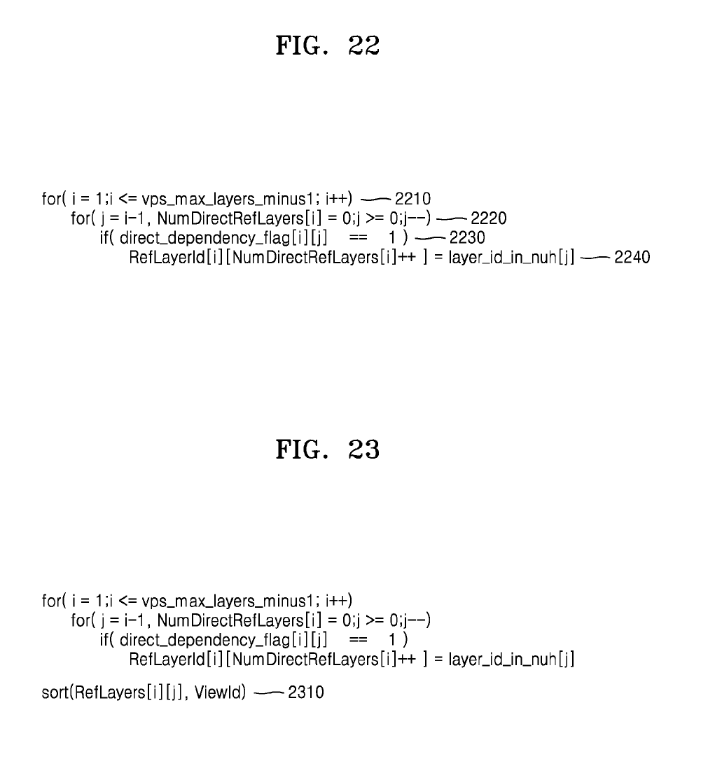

A key picture is a random access point. When an arbitrary playback point is selected from among pictures arranged in a picture playback sequence, that is, a POC sequence during video playback, a key picture corresponding to the closest POC sequence to the playback point is played back. First layer pictures include default viewpoint key pictures 41, 42, 43, 44, and 45, second layer pictures include left viewpoint key pictures 141, 142, 143, 144, and 145, and third layer pictures include right viewpoint key pictures 241, 242, 243, 244, and 245. As shown in FIG. 22, an inter layer estimation may be performed to pictures included in multi-layers with reference to not only a picture on a same layer, but also a picture on another layer.

The video encoder 1410 encodes a random access point (RAP) picture, which is set for random access, from among pictures included in multi-layers without performing inter layer estimation. Examples of RAP pictures include an instantaneous decoding refresh (IDR) picture, a clean random access (CRA) picture, a broken link access (BLA) picture, a temporal sublayer access (TSA) picture, and a stepwise temporal sublayer access (STSA) picture. Such a RAP picture is encoded via an intra estimation without referring to another picture. The video encoder 1410 may perform an inter layer estimation with respect to non-RAP pictures from among pictures included in multi-layers. A RAP picture may be used as a reference picture for another layer.

The video encoder 1410 may determine referring relationships between pictures included in multi-layers via an intra estimation, an inter estimation, and an interlayer estimation. In other words, the video encoder 1410 may determine based on which of pictures each of pictures included in multi-layers is estimation-encoded. An optimal reference picture referred by each of pictures may be determined based on rate-distortion cost or a referring relationship between input picture sequences may be determined based on designated encoding rules set in advance by the video encoder 1410.

For a decoder to restore a picture, it is necessary to transmit information regarding a reference picture to be referred by the picture encoded via an inter estimation or an intra estimation. Therefore, a (RPS) information generator 1420 generates RPS information regarding reference pictures referred by respective pictures included in multi-layers. RPS information may be information indicating whether pictures previously restored and stored in a decoded picture buffer (referred to hereinafter as a DPB′) are used as reference pictures of a current picture and pictures after the current picture. Particularly, RPS information according to an exemplary embodiment further includes interlayer RPS information indicating a referencing relationship for an interlayer estimation between pictures, which are included in a same access unit (AU) and transmitted, in consideration of a referring relationship interlayer-estimated in multi-layer video. A same AU may include pictures having a same output time, that is, a same POC. Interlayer RPS information may include information regarding whether a picture, which has a same POC as that of a current picture, is included in different layers, is previously restored, and is stored in a DPB, is used as a reference picture for interlayer estimation of the current picture.

The video encoder 1410 may construct a reference picture list by using the RPS information. Reference pictures may be added to the reference picture list in the same order as that of reference pictures included in the RPS information. The video encoder 1410 may prediction-encode a current picture based on the reference pictures identified in the reference picture list. The reference picture list may be used to reduce reference picture information transmitted in a prediction unit (PU) by using a reference picture index. The RPS information generator 1420 may adjust an order of pictures included in the RPS information and allocate a small number of reference picture indexes to a reference picture that is frequently used to prediction-encode the current picture, thereby increasing encoding efficiency. That is, the RPS information generator 1420 generates the RPS information in which the reference picture used to prediction-encode the current picture is located at the front of the RPS information, and thus the small number of reference picture indexes of the reference picture list may be allocated to the reference picture that is frequently used to prediction-encode the current picture.

The video encoder 1410 according to an exemplary embodiment may generate the reference picture list by using the inter layer RPS information indicating a reference relationship included in the RPS information during inter layer prediction. The inter layer RPS information according to an exemplary embodiment may include identification information of at least one reference layer that may be referred to when a picture of a current layer is inter layer predicted. According to the inter layer RPS information, when the picture of the current layer is inter layer predicted, a picture having the same picture order count (POC) as that of the picture of the current layer among a picture of each reference layer may be referred to.

The inter layer RPS information may be present with respect to a layer excluding a base layer. That is, inter layer prediction of a base layer is not performed, and thus inter layer RPS information of the base layer may not be present.

Since reference layers are added to the reference picture list in the same order as that of reference layers included in the inter layer RPS information, the RPS information generator 1420 may generate the inter layer RPS information such that the small number of reference picture indexes may be allocated to a reference layer that is frequently used to prediction-encode a current layer. That is, the RPS information generator 1420 may generate the inter layer RPS information in which the reference layer used to prediction-encode the current layer is located at the front of the inter layer RPS information. A layer closest to the current layer may be determined to be most similar to a picture of the current layer, and thus the layer closest to the current layer may be the reference layer that is frequently used to prediction-encode the current layer. Thus, the RPS information generator 1420 may generate the inter layer RPS information to include the reference layers in a descending order of differences in layer index values between the current layer and the reference layers.

To enable the small number of reference picture indexes to be allocated to the reference picture that is frequently used to prediction-encode the current picture, after generating the reference picture list, a reference picture order of the reference picture list may be corrected through a list correction process. According to an exemplary embodiment, the reference picture list is generated according to the inter layer RPS information to which the reference layers are added in an order closer to the current layer, and thus signaling for correcting a reference layer order may be minimized.

In addition, the RPS information generator 1420 may realign the reference layers included in the inter layer RPS information in further consideration of an index value of each reference layer according to scalability dimension information and of the layer index value. For example, when the scalability dimension information is multiview, a view index value according to a multiview type of each layer may mean view information of each layer. That is, photographing time of pictures of each layer may be identified according to the view index value of each layer. For example, when the view index value of each layer is 1, the photographing time of each layer may be determined as a center view, when the view index value of each layer is 0, the photographing time of each layer may be determined as a left view, and when the view index value of each layer is 2, the photographing time of each layer may be determined as a right view.

When a time of the current layer is the same as that of the reference layer or a difference in the view index values between the current layer and the reference layer is smaller, since a view difference is smaller, each picture of the current layer and each picture of the reference layer may be determined to be most similar to each other in a same POC. That is, a reference layer that is less different from the current layer in the view index value than other reference layers may be frequently used to prediction-encode or decode the current layer. Thus, the RPS information generator 1520 according to an exemplary embodiment may realign reference layers of the inter layer RPS information according to the view index value of each reference layer. In more detail, the RPS information generator 1420 may realign the reference layers included in the inter layer RPS information such that a reference layer that is the smallest different from the current layer in the view index value is located at the front of the inter layer RPS information.

FIG. 15 is a flowchart showing a method of encoding multi-layer video, according to an exemplary embodiment.

Referring to FIG. 15, in operation 1510, the video encoder 1410 performs intra estimations inter estimations and interlayer estimations with respect to pictures included in multi-layers and determines referring relationships between the pictures included in the multi-layers.

In operation 1520, the RPS information generator 1420 generates RPS information, which is information regarding reference pictures referred by the respective pictures, based on referring relationships, an encoding sequence, and an outputting sequence between multi-layer pictures. The RPS information may include inter layer RPS information including identification information of reference layers aligned according to a difference in a layer index value between a current layer and each reference layer. As described above, RPS information of each picture may be transmitted by being included in a slice header of each picture. The RPS information generator 1420 may generate the RPS information of each multilayer picture and add the RPS information to a slice header of a current picture. In addition, the RPS information generator 1420 may generate the inter layer RPS information of each reference layer for inter layer prediction of the current layer and add the inter layer RPS information to the slice header of the current picture.

In particular, the inter layer RPS information may be generated such that a reference layer that may be frequently used to prediction-encode the current layer according to an exemplary embodiment may have a priority. That is, the inter layer RPS information may include information regarding aligned reference layers in a descending order of the differences in the layer index values between the current layer and the aligned reference layers. In other words, the inter layer RPS information of the current layer may be generated by adding identification information of the reference layers to the inter layer RPS information in the descending order of the differences in the layer index values between the current layer and the aligned reference layers.

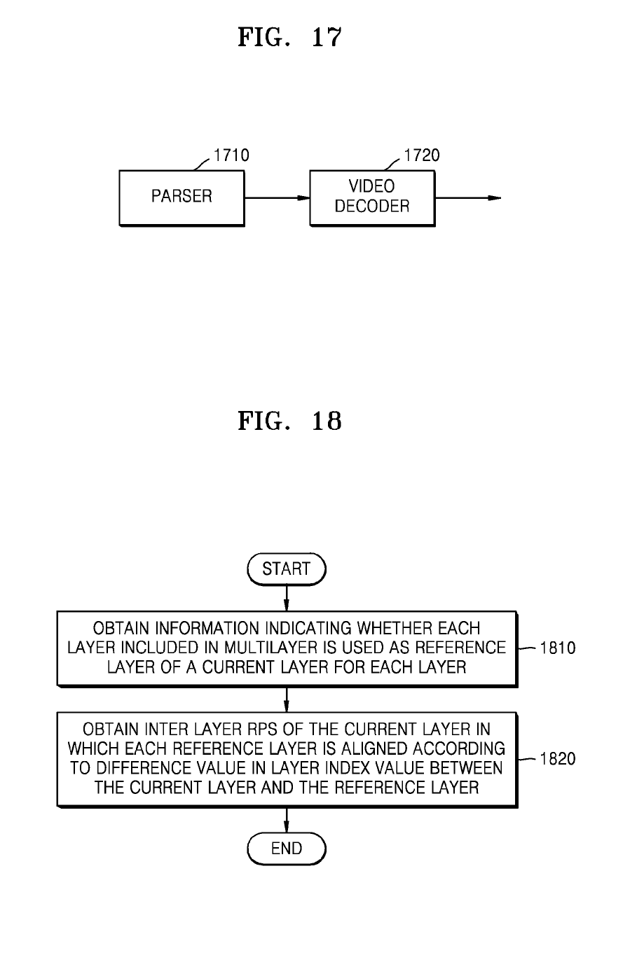

FIG. 17 is a block diagram of a multi-layer video decoding apparatus 1700 according to an exemplary embodiment.

Referring to FIG. 17, the multi-layer video decoding apparatus 1700 includes a parsing unit 1710 (e.g., a parser, etc.) and a video decoder 1720.

The parsing unit 1710 receives an encoded bitstream and obtains a video parameter set (VPS), a sequence parameter set (SPS), a picture parameter set (PPS), a slice, and a SEI message from the bitstream. Particularly, the parsing unit 1605 obtains RPS information for determining referring relationships between pictures included in encoded multi-layers from the bitstream. RPS information is included in the slice header of each picture, and RPS information is decoded before each picture is decoded. RPS information may include interlayer RPS information indicating referring relationships for interlayer estimation between pictures of multi-layers that are included in a single AU and have a same POC. In other words, interlayer RPS information includes information regarding reference pictures that are referred by a current picture for interlayer estimation. For example, the inter layer RPS information may include layer ID layer_id_nuh information of the reference layer.

The inter layer RPS information according to an exemplary embodiment may include identification information of reference layers aligned according to differences in layer index values between the current layer and the reference layers. The parser 1710 may sequentially determine whether each layer is a reference layer of the current layer in an order of small differences in the layer index values between the current layer and the reference layers, i.e., in a descending order of the differences in the layer index values between the current layer and the reference layers. For example, the parser 1710 may determine whether each layer is the reference layer of the current layer in a descending order based on a layer identification value of the current layer. If the layer identification value of the current layer is i, the parser 1710 may sequentially determine whether each layer is the reference layer of the current layer from i−1 to 0 in a descending order. The parser 1710 may add identification values of layers that are determined as the reference layers to the inter layer RPS information in such an order that each layer is the reference layer of the current layer. Thus, the parser 1710 may obtain the inter layer RPS information in which a reference layer having a smallest difference in the layer identification values between the current layer and the reference layer is present first. For example, when a layer having the layer identification value as i−1 is determined as the reference layer of the current layer, the layer identification value of i−1 may be a first value in the inter layer RPS information. The identification values of the layers that are determined as the reference layers may be included in the inter layer RPS information as next order values in a descending order from i−1.

In addition, the parser 1710 may realign the reference layers of the inter layer RPS information in further consideration of an index value according to scalability dimension information. For example, when the scalability dimension information is a multiview, the parser 1710 may realign the reference layers included in the inter layer RPS information according to a view index value of each reference layer. That is, the parser 1710 may realign the reference layers included in the inter layer RPS information in an order of small differences in the view index values between the current layer and the reference layers.

For example, it is assumed that layer 0 is a layer of a left view (a view index of 0), layer 1 is a layer of a center view (a view index of 1), layer 2 is a layer of a right view (a view index of 2), layer 3 is a first enhancement layer of the left view (a view index of 0), layer 4 is a first enhancement layer of the center view (a view index of 1), and layer 5 is a first enhancement layer of the right view (a view index of 2). It is assumed that when the current layer is the layer 5, the inter layer RPS information is {4, 2, 1, 0} (sequentially the layers 4, 2, 1, 0).

When the reference layers of the inter layer RPS information are realigned according to an exemplary embodiment, the inter layer RPS information may be realigned from {4, 2, 1, 0} to {2, 4, 1, 0} according to the view index values between the reference layers and the current layer.

The video decoder 1710 decodes pictures included in a multilayer. The video decoder 1710 may determine a reference relationship between the pictures included in the multilayer and decode each of the pictures according to a prediction mode of each picture. The video decoder 1710 may decode a multilayer video based on coding units having a tree structure.

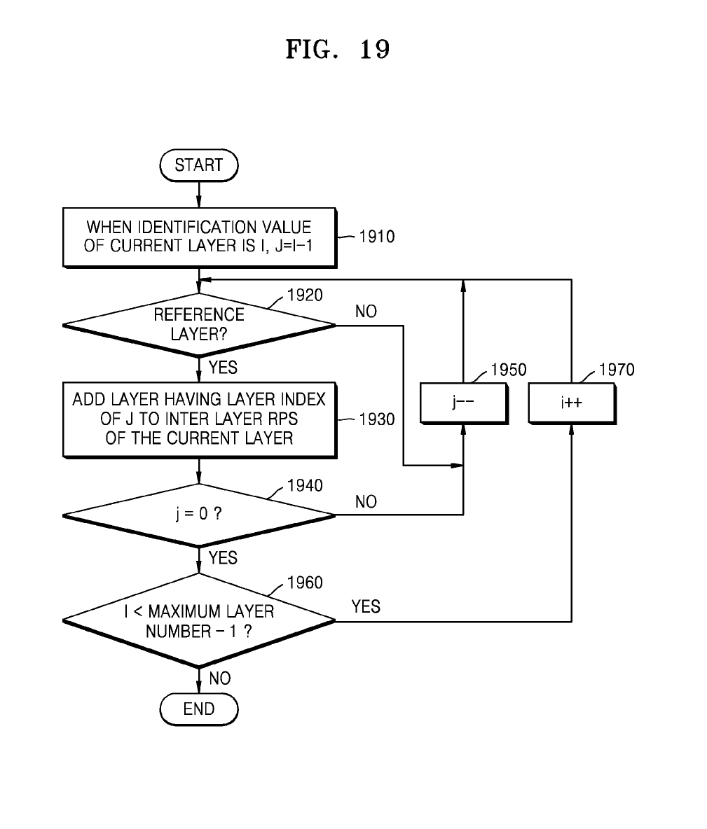

FIG. 18 is a flowchart of a method of prediction decoding a multilayer video by obtaining an inter layer RPS according to an exemplary embodiment.

In operation 1810, the parser 1710 may obtain information indicating whether each of layers included in a multilayer is used as a reference layer of a current layer, for each layer. For example, the parser 1710 may determine whether each layer is the reference layer of the current layer in a descending order based on a layer identification value of the current layer and add each layer to the inter layer RPS of the current layer according to a determination result.

In operation 1820, the parser 1710 may obtain the inter layer RPS of the current layer in which reference layers are aligned according to differences in layer index values between the current layer and the reference layers. The parser 1710 may determine whether each layer is the reference layer of the current layer in a descending order based on the layer identification value of the current layer, thereby sequentially adding each layer to the inter layer RPS of the current layer as the reference layer of the current layer according to the determination result. Thus, the reference layers included in the inter layer RPS of the current layer may be aligned in a smallest order of differences in the layer index values between the current layer and the reference layers.

FIG. 19 is a flowchart of a method of obtaining an inter layer RPS of a current layer according to an exemplary embodiment.

In operation 1910, the parser 1710 may have j as i−1 when a layer identification value of the current layer is i. Thus, according to an exemplary embodiment, it may be determined whether layers from a layer i−1 having a smallest difference in the layer identification values between the current layer and the layers correspond to reference layers among subordinate layers of the current layer.

Hereinafter, a layer having the layer identification value of i is referred to as a layer i.

In operation 1920, the parser 1710 may determine whether the layer j is a reference layer of the current layer i. When the parser 1710 determines that the layer j is the reference layer of the current layer i in operation 1920, in operation 1930, the parser 1710 may add the layer j to the inter layer RPS of the current layer. The parser 1710 may add layer IDs to the inter layer RPS in an order of layers that are determined as reference layers. Thus, according to an exemplary embodiment, when layers from a layer having a smaller difference in the layer identification values between the current layer and the layers among reference layers of the current layer are added to the inter layer RPS, the reference layers included in the inter layer PRS may be aligned in a smallest order of layer identification values between the current layer and the reference layers.

In the meantime, when the parser 1710 determines that the layer j is not the reference layer of the current layer i in operation 1920, in operation 1950, j may be redefined as a value of j−1 to determine whether the layer j is the reference layer of the current layer i in operation 1920. When a value of j is determined not to be 0 in operation 1940, j may be redefined as the value of j−1 in operation 1950 to determine whether the layer j is the reference layer of the current layer i in operation 1920.

In operation 1960, when a value of i is smaller than a value that is smaller by 1 than a previously determined layer number, the parser 1710 may redefine i as a value of i+1 to obtain an inter layer RPS of another layer. In the meantime, in operation 1960, when the value of i is equal to or greater than the value that is smaller by 1 than the previously determined layer number, the parser 1710 may determine that inter layer RPSs of all layers are obtained and may complete a process of obtaining the inter layer RPS. The layer identification value may be present from 0, and thus the value that is smaller by 1 than the previously determined layer number and i may be compared.

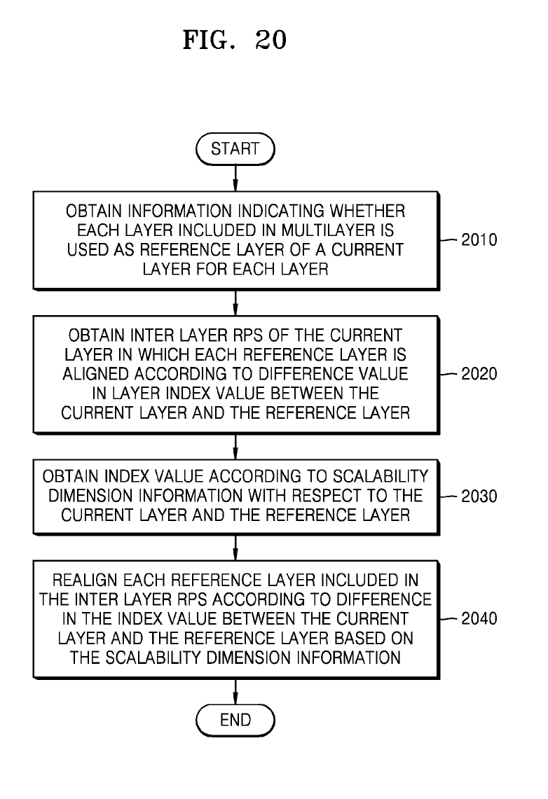

FIG. 20 is a flowchart of a method of obtaining an inter layer RPS based on scalability dimension information according to an exemplary embodiment.

Referring to FIG. 20, in operation 2010, the parser 1710 may obtain information indicating whether each of layers included in a multilayer is used as a reference layer of a current layer, for each layer. For example, the parser 1710 may determine whether each layer is the reference layer of the current layer in a descending order based on a layer identification value of the current layer and add each layer to the inter layer RPS of the current layer according to a determination result.

In operation 2020, the parser 1710 may obtain the inter layer RPS of the current layer in which reference layers are aligned according to differences in layer index values between the current layer and the reference layers. The parser 1710 may determine whether each layer is the reference layer of the current layer in a descending order based on the layer identification value of the current layer, thereby sequentially adding each layer to the inter layer RPS of the current layer as the reference layer of the current layer according to the determination result. Thus, the reference layers included in the inter layer RPS of the current layer may be aligned in a smallest order of differences in the layer index value between the current layer and the reference layers.

In operation 2030, the parser 1710 may obtain an index value according to scalability dimension information with respect to the current layer and the reference layers. The reference layers, of which index values according to the scalability dimension information is obtained by the parser 1710, may be at least one of reference layers included in the inter layer RPS of the current layer. A scalability dimension information scalability_mask may be signaled after being included in a video parameter set (VPS) of a multilayer video in which each layer may have an index value (for example, view_id) according to scalability dimension information scalability_mask[i]. For example, when the scalability dimension information (scalability_mask[i]=1) corresponds to a multiview type having a value of 1, each layer i having the scalability dimension information scalability_mask[i] as 1 may have a view index value according to the multiview.

In operation 2040, the parser 1710 may realign the reference layers included in the inter layer RPS according to differences in the index value according to the scalability dimension information between the current layer and the reference layers.

For example, when the scalability dimension information is the multiview, each layer may have the view index value according to the multiview. The parser 1710 may realign the reference layers included in the inter layer RPS by using the view index value of each layer obtained in operation S2030. That is, the parser 1710 may realign the reference layers included in the inter layer RPS in a smallest order of differences in the view index values between the current value and the reference layers.

According to an exemplary embodiment, reference layers that may be frequently used to prediction-decode the current layer are aligned at the front of the inter layer RPS, and thus a small number of reference picture indexes may be allocated to reference layers that may be frequently used to construct a reference picture list from the inter layer RPS, thereby increasing encoding efficiency.

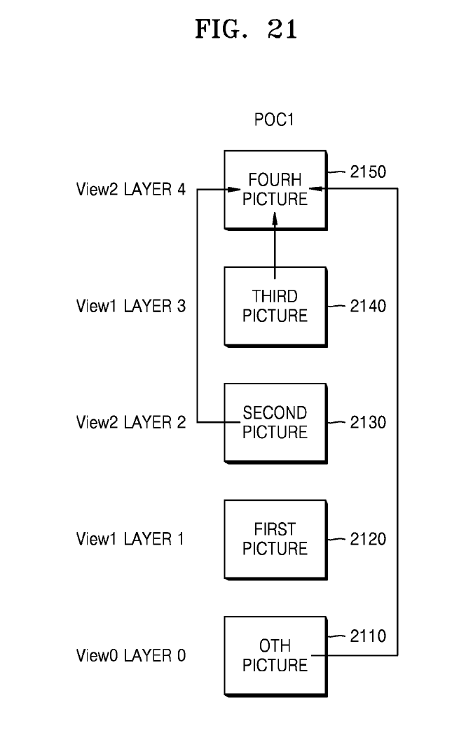

FIG. 21 is a diagram of an example of a method of obtaining an inter layer RPS according to an exemplary embodiment.

Referring to FIG. 21, it is assumed that a 0^{th} picture 2110 of a base layer having a layer identification value of 0, a second picture 2130 of a layer 2, and a third picture 2140 of a layer 3 are a fourth picture 2150 of a layer 4. In this case, inter layer RPS information RefPicSetIvCurr among RPS information of the fourth picture 2150 of the layer 4 may include the 0^{th} picture 2110, the second picture 2130 of the layer 2, and the third picture 2140 of the layer 3 that may be used as reference layers during inter layer prediction.

The parser 1710 may obtain information indicating whether the layers 3, 2, 1, and 0 are sequential reference layers of the layer 4 so as to obtain an inter layer RPS of the layer 4. The parser 1710 may obtain the inter layer RPS of the layer 4 based on the obtained information. The layer 4 may be prediction-decoded by referring to the layers 3, 2, and 0 as defined above, and thus the parser 1710 may obtain the inter layer PRS in which reference layer information is aligned in an order of the layers 3, 2, and 0.

In addition, the parser 1710 may realign reference layers of the inter layer RPS of the layer 4 in further consideration of view index information of each layer. That is, the parser 1710 may have the layer 2 having a view index value of 2 that is the same as the view index value of the layer 4 as priority. Thus, the parser 1710 may obtain the inter layer PRS in which the reference layer information is aligned in an order of the layers 2, 3, and 0.

FIG. 22 illustrates a code of an example of obtaining an inter layer RPS according to an exemplary embodiment.

Referring to FIG. 22, information direct_dependency_flag[i][j] for determining whether each layer j is a reference layer of a current layer i in a descending order from i−1 may be obtained.

Each layer i of which inter layer RPS information may be obtained may include layers from a layer having a layer index value of 1 to a layer having a value vps_max_layers_minus1 that is smaller by 1 than a maximum layer number previously determined in a VPS as shown in line 2210.

In for( ) 2220, NumDirectRefLayers[i] means the number of reference layer of the layer i, and may increase by 1 when the reference layer j is added to the inter layer RPS. Lines 2230 and 2240 of an if statement may be performed on j in a descending order j-- from i−1. Thus, according to an exemplary embodiment, it may be determined whether layers from a layer closest to the current layer are the reference layers of the current layer, and the reference layers may be added to inter layer RPS information of the current layer in a determination order.

direct_dependency_flag 2130 indicates whether the layer j is used as a reference layer of the layer i. When direct_dependency_flag 2130 has a value of 1, the layer j is used as the reference layer of the layer i.

RefLayerId[i][NumDirectRefLayers[i]++] 2240 means inter layer RPS information of the layer i. In direct_dependency_flag[i][j]==1 2230, a value of a layer ID layer_id_nug[j] of the layer j may be added to the inter layer RPS.

FIG. 23 illustrates a code of an example of obtaining an inter layer RPS based on scalability dimension information according to an exemplary embodiment.

Referring to FIG. 23, sort(RefLayerId[i][j], ViewId) 2310 may be further added to the code of FIG. 22.

sort is a code for realigning the reference layers j of RefLayerId[i][j] that is inter layer RPS information of the current layer i based on ViewId of the current layer i. The reference layers included in the inter layer RPS information may be realigned in a smaller order of differences in a ViewID value based on the ViewId of the current layer i or in a descending order. j of RefLayerId[i][j] may not be a layer identification value of a reference layer but may be a value defined by NumDirectRefLayers[i] and indicating an alignment order of the reference layers. For example, a first reference layer among the inter layer RPS of the current layer i may be RefLayerId[i][1].

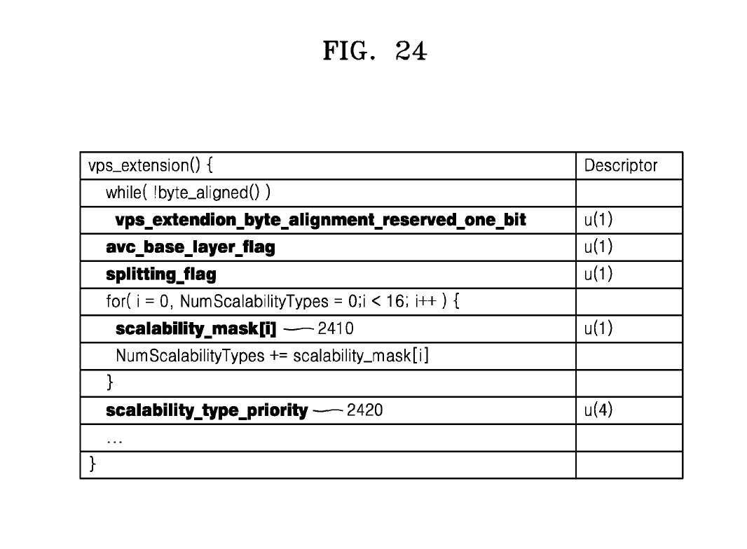

FIG. 24 illustrates a syntax of an example of obtaining scalability dimension information according to an exemplary embodiment.

VPS_extension( ) may include the scalability dimension information scalability_mask[i] 2410 of each layer and scalability_type_priority 2420 indicating whether which type of scalability dimension information is used to realign inter layer RPS information. VPS_extension( ) may include parameter information that may be commonly applied to a multilayer.

The scalability_type_priority 2420 may have a value from 0 to 15. When scalability_type_priority 2420 has a value of 1, each layer may have a View Id value according to a multiview type.

If a type of scalability dimension information that is used to realign inter layer RPS information is determined according to the scalability_type_priority 2420, an index value may be obtained according to scalability dimension information of the layer i having a value of the scalability_mask[i] 2410 that is the same as a value of the scalability_type_priority 2420.

For example, when the value of the scalability_type_priority 2420 is 1, an inter layer RPS of a layer having the value of the scalability_mask[i] 2410 of 1 may be realigned. That is, reference layers included in the inter layer RPS may be realigned in a small order of differences between a ViewId value of the layer having the value of the scalability_mask[i] 2410 of 1 and a ViewId value of each of the reference layers included in the inter layer RPS.

According to the exemplary embodiments, an inter layer PRS of layers included in a multilayer video may be generated such that a small number of reference picture indexes may be allocated to a frequently used reference layer.

Exemplary embodiments can also be embodied as computer (including any device that has an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

Moreover, while not restricted thereto, an exemplary embodiment can include one or more units embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. A exemplary embodiment may also be written as a computer program transmitted over a computer-readable transmission medium, such as a carrier wave, and received and implemented in general-use or special-purpose digital computers that execute the programs.

While exemplary embodiments have been particularly shown and described with reference to the drawings, it will be understood by those of ordinary skill in the art that various changes in form and details may be made therein without departing from the spirit and scope of the inventive concept as defined by the following claims.

1. A method of prediction decoding a multilayer video, the method comprising:
for each layer of a multilayer video, obtaining information indicating whether a layer included in the multilayer video is used as a reference layer of a current layer; and
obtaining an inter layer reference picture set (RPS) of the current layer in which each reference layer is aligned according to a difference value in a layer index value between the current layer and a layer used as the reference layer of the current layer based on the obtained information.

2. The method of claim 1, wherein the obtaining the information comprises: for each layer that belongs to a subordinate layer of the current layer, sequentially obtaining information indicating whether a is the reference layer of the current layer in a descending order based on the layer index value of the current layer,
wherein the inter layer RPS comprises at least one reference layer aligned in an order in which the information is obtained.

3. The method of claim 1, further comprising: realigning at least one reference layer included in the inter layer RPS according to scalability dimension information of the current layer.

4. The method of claim 3, further comprising: obtaining an index value according to the scalability dimension information with respect to each layer,
wherein the realigning of the at least one reference layer comprises: realigning the at least one reference layer included in the inter layer RPS according to a difference in the index value of the scalability dimension information between the current layer and the at least one reference layer.

5. The method of claim 1, further comprising:
obtaining a reference picture list with respect to the current layer according to an order of reference layers included in the inter layer RPS; and
prediction decoding the current layer according to the reference picture list.

6. An apparatus for decoding a multilayer video, the apparatus comprising:
a parser configured to, for each layer of a multilayer video, obtain information indicating whether a layer included in the multilayer video is used as a reference layer of a current layer, and configured to obtain an inter layer reference picture set (RPS) of the current layer in which each reference layer is aligned according to a difference value in a layer index value between the current layer and a layer used as the reference layer of the current layer based on the obtained information; and
a video decoder configured to prediction decode a picture of the current layer.

7. The apparatus of claim 6, wherein the parser is further configured to, for each layer that belongs to a subordinate layer of the current layer, sequentially obtain information indicating whether a layer is the reference layer of the current layer in a descending order based on the layer index value of the current layer,
wherein the inter layer RPS comprises at least one reference layer aligned in an order in which the information is obtained.

8. The apparatus of claim 6, wherein the parser is further configured to realign at least one reference layer included in the inter layer RPS according to scalability dimension information of the current layer.

9. The apparatus of claim 8, wherein the parser is further configured to obtain an index value according to the scalability dimension information with respect to each layer, and realign the at least one reference layer included in the inter layer RPS according to a difference in the index value of the scalability dimension information between the current layer and the at least one reference layer.

10. The apparatus of claim 6, wherein the parser is further configured to obtain a reference picture list with respect to the current layer according to an order of reference layers included in the inter layer RPS, and
wherein the video decoder is further configured to prediction decode the current layer according to the reference picture list.

11. A method of prediction encoding a multilayer video, the method comprising:
for each layer included in a multilayer video, determining information indicating whether a layer is used as a reference layer of a current layer; and
obtaining an inter layer reference picture set (RPS) of the current layer in which each reference layer is aligned according to a difference value in a layer index value between the current layer and a layer used as the reference layer of the current layer based on the determined information.

12. The method of claim 11, wherein the determining comprises:
for each layer that belongs to a subordinate layer of the current layer, sequentially determining information indicating whether a layer is the reference layer of the current layer in a descending order based on the layer index value of the current layer,
wherein the inter layer RPS comprises at least one reference layer aligned in an order in which the information is determined.

13. The method of claim 11, further comprising: realigning at least one reference layer included in the inter layer RPS according to scalability dimension information of the current layer.

14. The method of claim 11, further comprising:
generating a reference picture list with respect to the current layer according to an order of reference layers included in the inter layer RPS; and
prediction encoding the current layer according to the reference picture list.

15. An apparatus for encoding a multilayer video, the apparatus comprising:
a video encoder configured to perform intra prediction, inter prediction, and inter layer prediction on pictures included in a multilayer video, and configured to, for each layer included in the multilayer video, determine information indicating whether a layer included in the multilayer video is used as a reference layer of a current layer; and
an RPS information generator configured to generate an inter layer reference picture set (RPS) of the current layer in which each reference layer is aligned according to a difference value in a layer index value between the current layer and a layer used as the reference layer of the current layer based on the determined information.
